(19) United States
(12) Patent Application Publication
(10) Pub. No.: US 2007/0118699 A1
(43) Pub. Date: May 24, 2007

(54) System and method for updating turbine controls and monitoring revision history of turbine fleet

(75) Inventors: Clayton Joseph Synard, Simpsonville, SC (US); John Richard Cole, Saratoga Springs, NY (US); Manvinder Singh Chhatwal, Simpsonville, SC (US)

Correspondence Address: NIXON & VANDERHYE P.C., 901 NORTH GLEBE ROAD, 11TH FLOOR, ARLINGTON, VA, 22203, US

(73) Assignee: General Electric Company, Schenectady, NY (US)

(21) Appl. No.: 11/285,083

(22) Filed: Nov. 23, 2005

(51) Int. Cl. G06F 13/28

(52) U.S. Cl. 711/144

(57) ABSTRACT

A method for updating control systems in a fleet of controlled devices, the method includes: controlling each of the controlled devices in the fleet with one of the control systems, wherein each control systems comprises software components having one more updates; releasing a new software update for installation to the control systems for the controlled devices; monitoring the control systems for each controlled device to obtain data regarding the software components in the control system, including the updates previously loaded into the control system; determining whether the new software update is appropriate for the control system in each controlled device; for the control systems for which the update is appropriate, notifying an operator of the control system of the availability of the update; allowing the operator to select whether to download the new update, and performing at least a semi-automatic installation of the new update if selected by the operator.

### BACKGROUND OF THE INVENTION

The present invention relates generally to computer control systems for industrial power generation machines, e.g., turbines. More particularly the invention relates to methods and systems for updating turbine control software and tracking the history of updates.

Turbine control updates are conventionally performed, at least partially, manually by a human user loading software updates individually into each control system for a turbine. In the past, tools have been developed to assist the user update control software. The updating process has not been fully automated. There remain certain turbine control modifications that are implemented manually by users.

Manual updating of control software is time consuming and problematic for an operator of turbine and the turbine manufacturer that supplies the updates. The potential problems include a failure of the operator to timely update controls with reduced need for manual actions, improper updating of controls, turbines operating with outdated control software, and lack of historical information regarding the updates that have been performed on a turbine. There is a long felt need for a method to automatically update turbine controls, monitor the loading of updates, and track which updates have been loaded on turbines.

### BRIEF DESCRIPTION OF THE INVENTION

A turbine software service pack updater, monitoring and tracking system has been developed. The system is a software automation tool that automatically updates turbine control software and requires limited user interaction. The system enhances the updating of turbine software controls by reducing or eliminating downtime of the turbine during the updating process and enables seamless modification of the controls. The monitoring system utilizes a Management and Diagnostics (M&D) system that on an ongoing basis identifies which turbine controls are to be updated and whether updates are available. The monitoring program also identifies the criticality of the update to the operation of the turbine. The tracking system records the control software downloaded updates previously loaded for each turbine controller in a turbine fleet. The system and method provides a novel means to update turbine control software and monitor the updates loaded into the control software for each turbine in a fleet.

A method has been developed for updating control systems in a fleet of controlled devices, e.g., turbines, the method includes: controlling each of the devices in the fleet with one of the control systems, wherein each control system comprises of software components having one or more updates; releasing a new software update for installation to the control systems for the controlled devices; monitoring the control systems for each controlled device to obtain data regarding the software components in the control system, including the updates previously loaded into the control system; determining whether the new software update is appropriate for the control system in each controlled device; for the control systems for which the update is appropriate, notifying an operator of the control system of the availability of the update; allowing the operator to select whether to download the new update, and performing at least a semi-automatic installation of the new update if selected by the operator.

The method may be applied to a fleet of steam turbines and the control systems for each turbine may comprise of control algorithms for the steam turbine. The software component may be customized by adding separate software to the software component and linked to data and control interfaces to the standardized software component.

The monitoring of each control system may include an onsite monitoring software program of the control system that reports the updates previously loaded to the software component. The onsite monitoring software program may reside in the control system of the turbine and automatically notify a central monitoring and update computer system.

The method may also be embodied as a method for updating control systems in a fleet of turbines, the method comprising: controlling each of the turbines in the fleet with one of the control systems, wherein each control systems comprises software components having one more updates and a reporting software program; releasing a new software update for installation to the control systems for the controlled devices; using a central monitoring system to interrogate the reporting software programs in each of the control systems to obtain data regarding the software components in the control system, including the updates previously loaded into the control system; determining whether the new software update is appropriate for the control system in each controlled device; for the control systems for which the update is appropriate, notifying an operator of the control system of the availability of the update; allowing the operator to select whether to download the new update, and performing at least a semi-automatic installation of the new update if selected by the operator.

A system has been developed for updating control systems in a fleet of turbines, the system comprising: a fleet of turbines each with a control system, wherein each control system comprises software components having one more updates and a reporting software program; a central computer system comprising a library of software updates for the control systems in the fleet and a remote monitoring software program; wherein the monitoring system interrogates the reporting software programs in each of the control systems to obtain data regarding the software components in the control system, including the updates previously loaded into the control system and determines whether the new software update is appropriate for the control system in each controlled device, and notifies an operator of the control system of the availability of the update.

### BRIEF DESCRIPTION OF THE DRAWINGS

FIG. 1 is a schematic diagram of a fleet of turbines, each having a software driven controller, and a central computer providing software updates and tracking which updates have been loaded

FIG. 2 is a flow chart of a exemplary updating and monitoring process performed by the updating system.

FIG. 3 is a flow chart of a prior art updating and monitoring process.

### DETAILED DESCRIPTION OF THE INVENTION

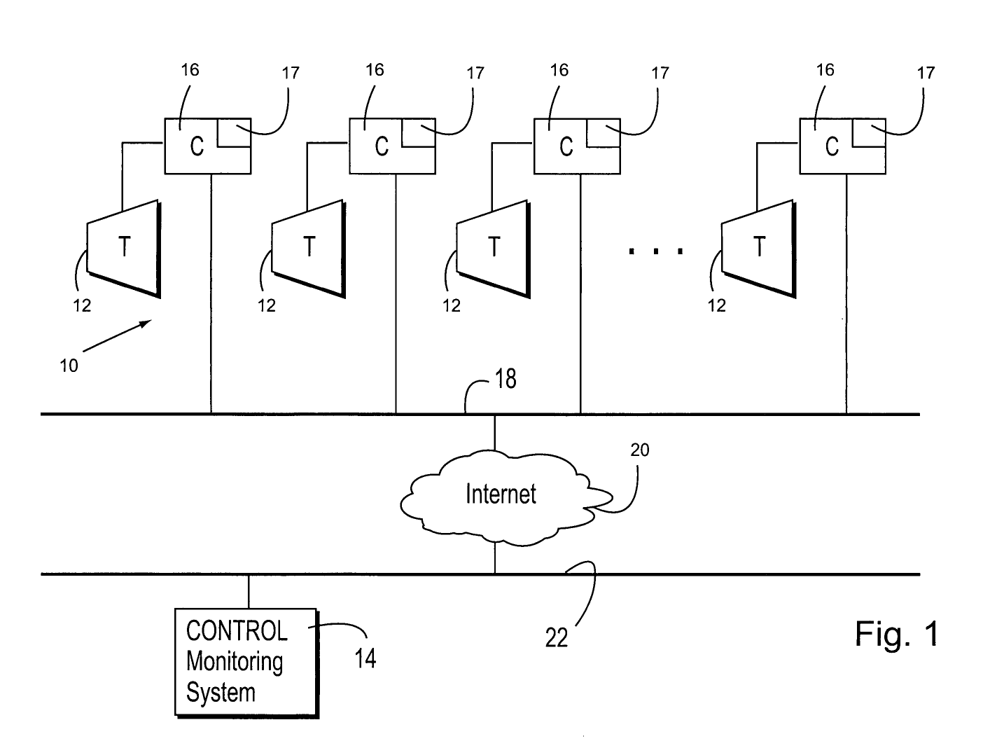

FIG. 1 is a schematic diagram of a fleet 10 of turbines 12, e.g., gas turbines or steam turbines, linked to a remote monitoring system 14. The fleet may be all turbines operating with a common control system. The fleet may be, for example, all of the turbines made or sold by a particular manufacture or all turbines in a particular model class sold by the manufacturer. A common feature of all turbines in the fleet is that their control system software is generally the same, but for differences in customization, software versions and software updates. The controller 16 for each turbine communicates via a network 18, e.g., a local area network (LAN) or wide area network (WAN), and the internet 20 to a network 22 that includes the monitoring system 14.

The turbine controller 16 for each turbine includes hardware and software control components. The hardware components may include controllable valves, actuators, sensors and other components conventionally used for turbine control. The software control components may include algorithms for processing data regarding the operation of the turbine, ambient conditions and user settings and for generating commands to control the valves and actuators in the turbine.

Software control components for a turbine are conventional and well known. The software control components typically are stored in a memory of the turbine controller 16, which comprises a computer and may include a personal computer owned by the turbine operator. The software control components may include algorithms, data inputs, control outputs and reporting features that provide automatic control of the turbine control system, user inputs to collect settings, and other control information provided by the operator, turbine monitoring features and reports to inform the operator regarding the status of the turbine.

The software control components of the controller are periodically updated. The updates typically are generated by the manufacturer of the turbine controller. The updates are loaded into each controller 16 for each turbine in the fleet 10. The turbine operator is usually given the option, for each update, as to whether to update the control software components and to select when the update is to be performed. If the update is not made to the software components of a particular controller, the associated turbine controller will likely continue to operate in the same manner that it had been performing. However, the controller will not have the benefits of the software upgrade, such as software code corrections, e.g., “bug fixes”, and enhanced control features. Some of the updates may be provided without charge, e.g., bug fixes, and some may require an additional payment to be made by the turbine owners. The turbine owner may decline updates that are fee based.

The software components will differ from controller to controller in the turbine fleet 10. Turbines are added to the fleet over time. Older turbines tend to have older versions of the software components than do newer turbines. Owners or operators of turbines may choose to load certain software updates, e.g., “service packs”, but not other service packs, and they may decline to accept the most current version of the turbine control software. In addition, the software updates are often loaded in the controllers at different times. The turbine owners and operators generally select when to load the updates in controllers of each turbine. The owners and operators may require custom software for their turbine controllers. The custom software increases the differences in the software components of the turbine controllers across the fleet. At any given time, the controllers of the fleet may have a variety of different software components even though all of the controllers have the same version (or family of versions) of software control components.

A computer, e.g., personal computer workstation, may be included with each controller 16. The computer stores the control software components and executes the components to control the turbine. The computer also includes software version reporting code 17 that tracks the version, updates and custom code already loaded on the software control components of that controller.

The remote monitoring system 14 is a communication device or service that monitors a fleet of turbine controllers 16 networked to the monitoring system. The monitoring system 14 identifies changes or upgrades that might be needed to a specific controllers 16. To update controller software components, the monitoring system activates a turbine live update software program to update the code of the components.

Using the reporting code 17 in each controller, the remote monitoring system inspects the turbine programmable controller 16 for each turbine 12 on a scheduled basis. The reporting code utilizes the network as a connection to the WAN to report the update history of the controller to the remote monitoring system. Using the update history, is used by the remote monitoring system to compare the update history of the software components in the controller to the available updates in a network database. The monitoring system notifies the turbine customer as well as itself whether an update for the turbine controller is required or contingent upon an agreement and whether or not the update is an enhancement or a bug fix, in step 22. If both the turbine customer and controller software supplier reach agreement regarding an update, a download of the software components is initiated to the controller. If a download cannot be initiated, a request can be made to the customer to supply a storage medium and that medium be shipped for installation on the controller.

Once the data is downloaded or shipped to the place of installation, e.g., the site of the turbine controller, a user interface on the controller is used by the customer to load the update to the software components of the controller. A user interface may present a license agreement to be accepted by the customer, before downloading of the software update is authorized. A live update software program loaded on the controller loads the selected updates into the software components of the controller.

The process of updating turbine controls starts with the development of application software for a bug fix or enhancement to the turbine controls. The update application software may be packaged in a tree file, which may be a structured file similar to XML (extend markup language) that is commonly used for parsing code, and organizes the packaged application software updates into nodes that are linked together.

When completed, the update software package is ready for downloading to turbine controllers. The remote monitoring system is activated and a list of turbines along with serial numbers is gathered. The reporting code 17 in each controller reports to the monitoring system the history of the software components that may include the version of the controller's software components, prior updates to the software components and the presence of custom code in the software components. Based on the received history, a decision is made by the remote monitoring system as to whether an update is appropriate and, later, whether the end user accepts the agreement. The customer is given the option to download updates, to the extent that the monitoring system determines that the customer's controller determines that the update is appropriate.

Once the turbines have been identified and update agreements accepted by customers, the turbine live update program is initiated and the update process of the application software is performed. Turbine live update identifies the current application code for the software components and creates a backup file of that code. If a file cannot be found, the update prompts the user to locate the correct or current application software file so that it to may be included in the backup file. After file preparations are complete, the import of the new upload is initiated and the old application software is replaced by the software code updates in the structured file. When the update is complete, a validation is performed to check for errors in the download process. If no errors exist, a prompt is issued to the end user for an immediate download of the update to the PLC (Programmable Logic Controller) for the control system 17. After the download is complete, the turbine update prompts the end user to restart their PLC and complete the installation.

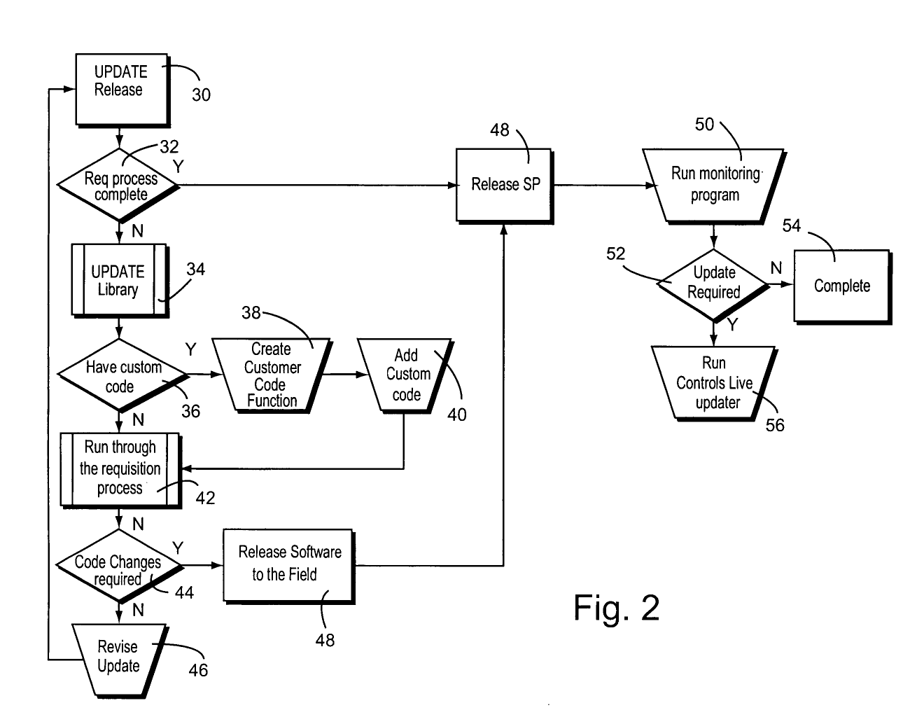

FIG. 2 is an exemplary software flow chart for the setting up of software controller updates and releasing the updates to the monitoring program to be distributed to the turbine fleet

In step 30, a software update is released by the supplier of the software components of the turbine controller. The software update is typically a new portion of software code that corrects a software error (bug fix) in the existing software components, or enhances the operation or adds new features to the control software. In step 32, the released update is processed through a registration procedure that ensures that the update is ready to be released to the turbine fleet. If the update has not already been registered, the update is added to an existing software update library in step 34. The update library may be a database of software updates for turbine controller software components. The library is maintained by the control monitoring system 14. The update library is, for example, an electronic storage location from which turbine customers may download software updates for their control system. The update library may compile the registered software updates. The library may have an index of the updates so that they may be easily accessible for download. The index may also indicate whether the update is desired or required.

In step 36, a determination is made as to whether the update relates to or may impact custom software codes that may have been added to individual turbine controllers. Custom codes are software modifications made for a turbine customer to their controller software components.

In the past, custom code modifications have been allowed to be made to the software components of the controller. It has been difficult to track and maintain consistency among controllers having various custom software modifications made on turbines in the fleet. In the past, it was common for individual turbine controllers to modify software components to provide customization desired by individual turbine operators. To minimize the difficulties associated with various customized software components, custom codes may be limited to add-on software programs that do not directly modify the code of standard software components of the controller. In particular, the code for the software components may be standardized and changed only by the updates to the standard software components. Custom code features may be added to the standard software components as, for example, custom PLC or RLD codes that are separate software codes linked to a specific data output and data input connections to the standard software components. In step 38, the custom code is created as a separate software program. The custom software program is linked to the standard software components of the controller using the input and output functions included in the standard software components. Once created, the custom code may be added to the update library in step 40. After step 36 and/or 40, the update, which has now been loaded in the update library and, if it involves custom code has been created as a separate custom code function.

The released update is tested to ensure that the updated code operates properly in the software components in the controller, as is indicated in step 42. After the testing process, a determination is made as to whether code changes that are needed in step 44. If changes are needed, the update is revised in step 46 and the processes of releasing the update (step 30) and testing (step 32) are repeated. If no code changes are needed, the software is identified to be available for release to the field in step 48.

The release of software to the turbine fleet in step 48 occurs after the registration process is completed, see step 32. The release of the software to the fleet is an authorization to allow the new update or updates to be loaded on the controllers of the turbines in the fleet. Before the update is downloaded to an individual turbine controller, a determination is made as to whether the controller requires the update and if the operator of that controller desires the update.

The monitoring program polls the controller for each turbine in the fleet to determine the version of software control components operating on the controller and the updates that have been previously loaded on the controller. To determine the version and updates on each controller, the reporting code 17 on each controller collects information regarding the current software version and update on the controller and sends the information to the monitoring system 14. The reporting code may be an onsite monitoring and diagnostic software program that may be loaded on a personal computer associated with the controller 16. The reporting code may automatically collect information regarding the control software version and updates, and report the information periodically to the control monitoring system. The reporting code may operate in a manner that is not normally noticed by the human turbine operator. Alternatively, the monitoring system may prompt the reporting code to provide the information. In addition, the control monitoring system may request information regarding control software version and updates from each controller by controlling the reporting code 17.

For each controller in the fleet, the monitoring system 14 determines whether available updates are required or desirable. If no updates are required or desirable for a controller, a determination is made that the update process is complete. The monitoring program moves to the next controller in the fleet, in step 54. If the monitoring program determines that a update is required or desired for a turbine controller, the monitoring program activates the live updates software program on the controller, in step 56. The live update initially notifies the turbine operator that one or more updates are available for the software control components of the controller.

The live update may also inform the operator whether the updates are available free of charge or if they have an associated cost. In addition, the live update may provide information about each update, such as whether the update is required for reliable operation of the controller, the features provided by the update, and the potential disadvantages that may occur in the controller is the update is not downloaded.

If the turbine operator chooses to download the software update, the operator accepts a licensing agreement provided by the live update to establish a contract for downloading the update and, if appropriate, arrange for payment for the update. The live update automatically downloads the update to the controller. To the extent necessary, the turbine operator monitors the update process and a valid serial number may be needed to enter information, such as registration information, during the update process. Preferably, the software update process occurs without having to stop the turbine or otherwise take the turbine offline.

The update process may initially include making a backup copy of the existing software components for the turbine. The software code files for the existing software components are identified and copied. The backup copy is stored in a secure location in the event that the update does not perform satisfactory, using the backup, the prior software components can be reloaded to the controller if necessary. The update may be performed to modify the software components and add a new custom code feature.

Because the custom code features do not represent modifications of the software components of the control systems, the risk is reduced that the updates are incompatible with the software components of the control system of any controller. An advantage of maintaining the software components of the control system unchanged during customization is that updates can be performed on the software components without substantial risk that the updates will be incompatible with prior customization of the control system.

If the updates are determined to be compatible with the various versions and the prior updates to the software components for the controller during the registration process, (step 32) the update is released. If it is determined that the updates are incompatible with certain versions or certain prior updates, the registration process identifies, using the update library (see step 34), that the new update is incompatible with the versions or updates on a particular controller. In the novel system disclosed herein, the monitoring program identifies incompatibilities for a new update indicated in the update library with the existing software components (e.g., the version and existing updates) on each controller in the turbine fleet. If a controller in the turbine fleet includes a software component version or had updates incompatible with a newly released update, the monitoring program indicates that the update is not required or requires that prior updates be first loaded in step 52.

Further, the monitoring program may obtain from the update library information regarding whether an available update requires one or more prior updates. The monitoring program may notify the turbine operator that a newly available update requires one or more prior updates before being loaded on the controller. In this way, the monitoring program reliably determine whether updates may be loaded into the software components of the controller to successfully achieve the desired enhanced software.

The live update confirms that the update has been successfully downloaded into the software components of the controller. Further, live update may conduct tests either automatically or with the assistance of the turbine operator to confirm that the updates have been successfully loaded and that the software components are properly operating in the controller. If the update is not successful or is not operating properly, the turbine operator may reject the update and reload the saved prior controller software components.

Preferably, the update process performed by the live update is conducted without taking the turbine offline. However, certain updates may potentially adversely effect the operation of the turbine if not performed successfully. The turbine operator may determine that the update should not be downloaded until the turbine is offline, such as during routine maintenance. The turbine operator can schedule the updating of the software components on the turbine control for period when the turbine is scheduled to be offline.

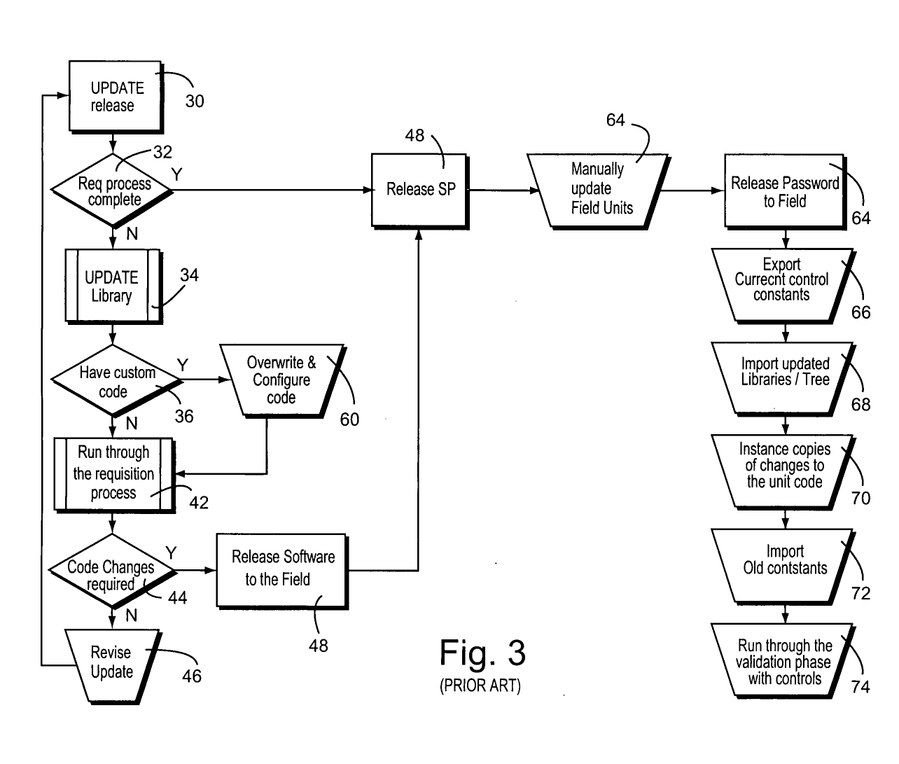

By way of comparison, FIG. 3 is a high level flow chart showing a prior art method for updating turbine control software. Where the prior process is similar to the process shown in FIG. 2, the some reference numbers have been used in FIG. 3. The process shown in FIG. 3 differs from the process in FIG. 2, in several respects including: overwriting and configuring controller software during a customization process, updating the field units of the control system in the fleet and in lacking an onsite monitoring and diagnostic system. In step 60, a turbine operator may request custom control code to have certain features in the control system that may not be available with the standard control software available from the turbine manufacture. In the conventional manner of customizing code, the software components of the controller are revised, overwritten and configured to perform a customized feature. The customization of the code substantially changes the software control components in the controller. Each controller having custom code modifications has a slightly software components than does the other turbine controllers in the fleet. In the past, tracking the customization of controller software and ensuring that new updates are compatible with all of the different customized control software has been particularly difficult. Accordingly, restricting customized codes to new software programs that are separate but linked to standard software components is a substantial advantage over prior techniques for customizing turbine software control code.

The past process for updating control systems 16 in the turbine fleet is different. The software updating was conventionally performed manually by controls engineers that worked on the controller for each turbine in the fleet in step 62. Typically, the controls engineer performing the manual update of the software control system used a password provided by the software supplier that authorizes the downloading of the update to the controller for a particular turbine, in step 64. The password may be released after the turbine operator agrees to license the software. To begin updating, the current control constants in the controller were exported to a central software control system in step 66. These control constant were saved. The control constants are typically the settings used by the controller for operating its associated turbine. The update is downloaded to the computer for the controller 16. The update may be software file libraries stored on a database on a central computer and downloaded as structured files to the controller in step 68.

In step 70, changes made to the existing software components on the controller were incorporated into the updated software components. These changes are typically needed to adapt to prior customization of the control system. To ensure that the customization is carried forward to the controller with a new update, it was necessary for the software engineer performing the update to make changes to the new software updates. The changes were needed to ensure that the customization previously made is not lost during the updating of the software components. The old control constants from steps 66 were imported to the new updated software components in step 72.

The software engineer performed a validation and testing phase to ensure that the updated software components for the control system 16 perform properly, in step 74. The software engineer may have performed additional modifications to the software components to achieve the desired operation of the customized control programs for the controller. Once the updated software has been validated, the software engineer typically allows the turbine to be brought back online and operated.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method for updating control systems in a fleet of controlled devices, the method comprising:
controlling each of the controlled devices in the fleet with one of the control systems, wherein each control systems comprises software components having one or more updates;
releasing a new software update for installation to the control systems for the controlled devices;
monitoring the control systems for each controlled device to obtain data regarding the software components in the control system, including the updates previously loaded into the control system;
determining whether the new software update is appropriate for the control system in each controlled device;
for the control systems for which the update is appropriate, notifying an operator of the control system of the availability of the update;
allowing the operator to select whether to download the new update, and
performing at least a semi-automatic installation of the new update if selected by the operator.

2. The method in claim 1 wherein the controlled device is a turbine and the control system comprises control algorithms for the steam turbine.

3. The method in claim 1 wherein the software components are customized by adding software separate to the software components and linked to data and control interfaces to the software components.

4. The method in claim 3 wherein the software components are not modified by customization for individual customers of the controlled device.

5. The method in claim 1 wherein monitoring each control system includes an onsite monitoring software program of the control system that reports the updates previously loaded to the software components.

6. The method in claim 1 wherein the software components comprise standard software components and logically separate customer software components, and the new software update is for the standard software components.

7. The method of claim 6 wherein the standard customer components are separate software code from the standard software components.

8. The method of claim 1 wherein monitoring the control systems is performed by sequentially interrogating the control system for each of the controlled devices.

9. The method of claim 1 wherein the updates comprise of software bug corrections and enhancements to software functions of the control system.

10. The method of claim 1 further comprising storing a backup copy of the software components of the control system before performing the at least a semi-automatic installation.

11. A method for updating control systems in a fleet of turbines, the method comprising:
controlling each of the turbines in the fleet with one of the control systems, wherein each control systems comprises software components having one more updates and a reporting software program;
releasing a new software update for installation to the control systems for the controlled devices;
using a central monitoring system to interrogate the reporting software programs in each of the control systems to obtain data regarding the software components in the control system, including the updates previously loaded into the control system;
determining whether the new software update is appropriate for the control system in each controlled device;
for the control systems for which the update is appropriate, notifying an operator of the control system of the availability of the update;
allowing the operator to select whether to download the new update, and
performing at least a semi-automatic installation of the new update if selected by the operator.

12. The method in claim 11 wherein the software components are customized by adding software separate to the software components and linked to data and control interfaces to the software components.

13. The method in claim 12 wherein the software components are not modified by customization for individual customers of the controlled device.

14. The method in claim 11 wherein the software components comprise standard software components and logically separate customer software components, and the new software update is for the standard software components.

15. The method of claim 14 wherein the standard customer components are separate software code from the standard software components.

16. The method of claim 11 wherein monitoring the control systems is performed by sequentially interrogating the control system for each of the controlled devices.

17. The method of claim 11 further comprising storing a backup copy of the software components of the control system before performing the at least a semi-automatic installation.

18. A system for updating control systems in a fleet of turbines, the system comprising:
a fleet of turbines each with a control system, wherein each control system comprises software components having one or more updates and a reporting software program;
a central computer system comprising a library of software updates for the control systems in the fleet and a remote monitoring software program;
wherein the monitoring system interrogates the reporting software programs in each of the control systems to obtain data regarding the software components in the control system, including the updates previously loaded into the control system and determines whether the new software update is appropriate for the control system in each controlled device, and notifies an operator of the control system of the availability of the update.

19. The system of claim 18 wherein the software components are customized by adding software separate to the software components and linked to data and control interfaces to the software components.

20. The system of claim 19 wherein the software components are not modified by customization for individual customers of the controlled device.
